(19) United States
(12) Patent Application Publication
(10) Pub. No.: US 2026/0350651 A1
(43) Pub. Date: Nov. 5, 2026

(54) FANDOM-INDEX MEASUREMENT AND REWARD METHOD

(71) Applicant: WEVERSE COMPANY INC., Seongnam-si, Gyeonggi-do (KR)

(72) Inventors: Sang Il SIM, Seongnam-si, Gyeonggi-do (KR); Hee Jae JEONG, Siheung-si, Gyeonggi-do (KR); Sun Duck LEE, Seoul (KR); Dong Hyun KIM, Yongin-si, Gyeonggi-do (KR); Shin Young PARK, Yongin-si, Gyeonggi-do (KR)

(73) Assignee: WEVERSE COMPANY INC., Seongnam-si, Gyeonggi-do (KR)

(21) Appl. No.: 18/873,262

(22) PCT Filed: Jun. 8, 2023
(86) PCT No.: PCT/KR2023/007883

§ 371 Date: Jul. 24, 2026

(30) Foreign Application Priority Data
Jun. 9, 2022 (KR) 10-2022-0070359

(51) Int. Cl. G06Q 30/0207

(52) U.S. Cl. CPC G06Q 30/0239

(57) ABSTRACT

A fandom-index measurement and reward method according to an embodiment of the present disclosure is a method by which at least one processor of a fan platform service server measures and rewards according to a fandom-index, and includes: collecting fan activity data on each fan user; determining, based on the collected fan activity data, the fandom-index including activity level information on the each fan user; providing ranking information between the fan users for a predetermined activity target based on the activity level information in the determined fandom-index; and providing a non-fungible token (NFT) reward according to the ranking information.

### TECHNICAL FIELD

The present disclosure relates to a fandom-index measurement and reward method. More specifically, the present disclosure relates to a fandom-index measurement and reward method, which creates a fandom-index representing the characteristics of various fan activities performed by fan users, and provides customized rewards to the fan users based on the created fandom-index.

### BACKGROUND ART

Fandom refers to a person or group of people who passionately like or are immersed in a specific person (especially a celebrity) or field.

Recently, services that provide fandom platforms, which are online spaces where these fandoms may gather and engage in activities, have been gaining attention.

In detail, the fandom platform service may refer to an online platform service that supports various fan activities, including various promotional activities, purchasing activities, and/or participation activities conducted online and offline through connections between fans and specific individuals or fields.

In the conventional technical field, in order to encourage more fan users to engage in more active and proactive fan activities on the fandom platform, a service that provides appropriate rewards to fan users who meet certain requirements is implemented.

However, in conventional reward services, the rewards to be issued to the fan users are merely determined within the scope of the usual rewards according to the universal reward system (for example, provision of a predetermined emblem, provision of ticket purchase rights, and/or provision of coupons). Hence, there is a limit to satisfying the reward satisfaction of fan users who have continuously performed fan activities or new generation fan users.

Accordingly, the need for development and introduction of a differentiated reward system that may more effectively improve the reward satisfaction of fan users is increasing day by day.

With the recent groundbreaking development of blockchain technology, the utilization of non-fungible tokens (NFTs) based thereon is expanding into various fields.

Herein, the NFT refers to a virtual token that proves the ownership of a digital asset using blockchain technology.

In detail, the NFT may be a type of virtual certificate of authenticity used to indicate its unique originality and ownership by including an address indicating a digital file, such as a certain image, video, and/or audio, in a token.

In other words, the NFT may mean a unique digital file format registered on a blockchain, and such NFT has the advantage that its economic value may gradually increase over time, so interest in the NFT is also increasing.

### DETAILED DESCRIPTION OF INVENTION

### Technical Problems

An aspect of the present disclosure is directed to providing a fandom-index measurement and reward method, which creates a fandom-index representing the characteristics of various fan activities performed by fan users, and provides customized rewards to the fan users based on the created fandom-index.

In addition, an aspect of the present disclosure is directed to providing a fandom-index measurement and reward method that provides a reward in a differentiated manner from conventional ones based on non-fungible token (NFT) technology.

### Technical Solution

A fandom-index measurement and reward method according to an embodiment of the present disclosure is a method by which at least one processor of a fan platform service server measures and rewards according to a fandom-index, and includes: collecting fan activity data on each fan user; determining, based on the collected fan activity data, the fandom-index including activity level information on the each fan user; providing ranking information between the fan users for a predetermined activity target based on the activity level information in the determined fandom-index; and providing a non-fungible token (NFT) reward according to the ranking information.

In this connection, the NFT reward is provided based on an NFT, which is a digital file registered on a blockchain.

In addition, the provision of the NFT reward according to the ranking information includes providing the NFT reward in at least one of an NFT free provision method or an NFT purchase right provision method.

In addition, the fan activity data includes at least one piece of parameter information among activity target information that specifies the activity target that is a target of a fan activity, activity section information that specifies a field of the fan activity, activity time information that specifies a time of the fan activity, activity type information that specifies details of the fan activity, activity response information that specifies responses of other users to the fan activity, and the activity level information that numerically specifies a level of the fan activity performed.

In addition, the provision of the NFT reward according to the ranking information includes: acquiring attribute information for the each NFT; comparing the acquired attribute information for the each NFT with attribute information of the fandom-index determined based on each parameter value of the fan activity data; detecting NFT attribute information corresponding to the attribute information of the fandom-index according to the comparison; and providing a customized NFT having the detected NFT attribute information as a reward.

In addition, the NFT attribute information includes at least one piece of parameter information among production target information that specifies a production target of the NFT, production section information that specifies a field of activity of the production target, production time information that specifies a time of production and use of the NFT, and production format information that specifies a data file format of the NFT.

In addition, the comparison of the attribute information for the each NFT with the attribute information of the fandom-index includes comparing each parameter value of the attribute information for the each NFT with each parameter value of the attribute information of the fandom-index corresponding thereto.

In addition, the provision of the customized NFT as the reward includes, when there are a plurality of detected customized NFTs, determining one of the plurality of customized NFTs as a customized main NFT based on priority information preset for each parameter of the attribute information of the fandom-index, and providing the determined customized main NFT as the reward.

In addition, the method further includes presetting the priority information, and the presetting of the priority information includes presetting the priority information based on at least one of sub-activity level information or default priority that divides the activity level information for each parameter of the attribute information of the fandom-index.

In addition, the collection of the fan activity data includes collecting first fan activity data based on an internal service and second fan activity data based on an external service.

In addition, the determination of the fandom-index includes collating the first fan activity data and the second fan activity data by corresponding parameter of each piece of fan activity data, wherein the collation by parameter includes determining comprehensive activity level information of the fandom-index by adding up first activity level information of the first fan activity data and second activity level information of the second fan activity data.

In addition, the provision of the NFT reward according to the ranking information includes: detecting at least some fan users who meet a predetermined criterion based on the activity level information among the fan users; and providing the NFT reward through terminals of the detected fan users.

A fandom-index measurement and reward method according to an embodiment of the present disclosure is a method by which a fan platform application executed by at least one processor of a fan terminal measures and rewards according to a fandom-index, and includes: creating fan activity data; acquiring the fandom-index according to the created fan activity data; providing predetermined ranking information based on activity level information in the acquired fandom-index; and providing a non-fungible token (NFT) reward according to the provided ranking information.

In this connection, the provision of the NFT reward according to the ranking information includes providing the NFT reward when a predetermined criterion based on the activity level information is satisfied.

In addition, the provision of the NFT reward according to the ranking information includes providing the NFT reward in at least one of an NFT free provision method or an NFT purchase right provision method.

### Effect of Invention

A fandom-index measurement and reward method according to an embodiment of the present disclosure creates and manages a fandom-index that represents the characteristics of various fan activities performed by fan users by matching the fan activity target and/or the corresponding fan users, thereby easily implementing various services (for example, fandom management, reward provision, and/or event planning) related to the fan activities based on systematized data.

In addition, the fandom-index measurement and reward method according to an embodiment of the present disclosure provides a customized reward that reflects a target of interest or preferred fan activity method of the corresponding fan user based on the fan activity history created based on the fandom-index, thereby providing a reward that has greater value to the fan user. Accordingly, the reward satisfaction of the fan user can be increased and more active and vibrant fan activities can be encouraged in the future.

In addition, the fandom-index measurement and reward method according to an embodiment of the present disclosure analyzes metadata according to the fandom-index and provides customized rewards based on the interests of the fan user, thereby inducing continuous participation of the fan user in fan activities.

In addition, the fandom-index measurement and reward method according to an embodiment of the present disclosure provides a reward in a differentiated manner from the conventional ones based on non-fungible token (NFT) technology, thereby increasing the continuous participation and interest of a wide range of fandom layers including fan users who have been performing fan activities for a long time and new-generation fan users. Accordingly, the user retention time on a fan platform service can be increased, and various benefits resulting from increased fan activities can be implemented more effectively.

### BRIEF DESCRIPTION OF THE DRAWING

FIG. 1 is a conceptual diagram illustrating a fandom-index measurement and reward system according to an embodiment of the present disclosure.

FIG. 2 is an internal block diagram illustrating a fan terminal according to an embodiment of the present disclosure.

FIG. 3 is a flowchart illustrating a fandom-index measurement and reward method according to an embodiment of the present disclosure.

FIG. 4 is an example showing a fan platform service according to an embodiment of the present disclosure.

FIG. 5 is an example showing a fandom-index according to an embodiment of the present disclosure.

FIG. 6 is an example of providing ranking information according to an embodiment of the present disclosure.

FIG. 7 is a flowchart illustrating a method for providing an NFT (non-fungible token) reward according to an embodiment of the present disclosure.

FIG. 8 is an example showing a method for providing a purchase right grant NFT reward according to an embodiment of the present disclosure.

### BEST MODE FOR CARRYING OUT THE INVENTION

Embodiments of the present disclosure will be shown in the drawings and described in detail through a detailed description. However, the present disclosure may be variously modified and embodied in a variety of different embodiments. Advantages and features of the present disclosure and implementation methods thereof will be clarified through the following embodiments described with reference to the accompanying drawings. Therefore, the present disclosure is not limited to these embodiments introduced hereinafter and might be embodied in a different shape from these embodiments. The terms “first,” “second,” and so on in the present disclosure are used for distinguishing one component from the other components, but they do not specify limited meanings. Also, the singular forms used in the present disclosure are intended to include the plural forms, unless the context clearly indicates otherwise. Moreover, the terms “comprises” and/or “having” described in the present disclosure specify the presence of stated components and/or features, but do not preclude the presence or addition of one or more other components and/or features. Furthermore, the size or the thickness of each component in the drawings can be exaggerated or reduced for the definiteness of explanation. For example, the size and the thickness of each component in the drawings are arbitrarily represented for the convenience of explanation. In accordance therewith, the present disclosure is not limited to the matters shown in the drawings.

Reference will now be made in detail to the embodiments of the present disclosure with reference to the accompanying drawings. Wherever possible, the same reference numbers will be used throughout the disclosure including the drawings to refer to the same or like parts. As such, the repeatable description of the same or like parts will be omitted.

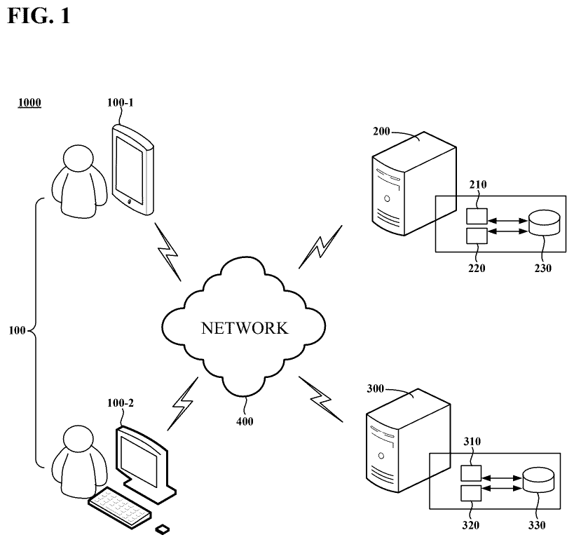

FIG. 1 is a conceptual diagram illustrating a fandom-index measurement and reward system according to an embodiment of the present disclosure.

Referring to FIG. 1 a fandom-index measurement and reward system 1000 according to an embodiment of the present disclosure may create a fandom-index that represents the characteristics of various fan activities performed by fan users, and implement a fandom-index measurement and reward service that provides customized rewards to the fan users based on the created fandom-index.

In an embodiment, the fandom-index measurement and reward system 1000 implementing the fandom-index measurement and reward service as described above may include a fan terminal 100, a fan platform service server 200, an external server 300, and a network 400.

In this connection, the fan terminal 100, the fan platform service server 200, and the external server 300 may be connected through the network 400.

Herein, the network 400 according to an embodiment refers to a connection structure capable of exchanging information between nodes such as the fan terminal 100, the fan platform service server 200, and/or the external server 300. Examples of the network 400 include 3GPP (3rd Generation Partnership Project) network, LTE (Long Term Evolution) network, WIMAX (World Interoperability for Microwave Access) network, Internet, LAN (Local Area Network), Wireless LAN (Wireless Local Area Network), WAN (Wide Area Network), PAN (Personal Area Network), Bluetooth network, Satellite Broadcasting Network, Analog Broadcasting Network, and DMB (Digital Multimedia Broadcasting) network, but are not limited thereto.

Hereinafter, the fan terminal 100, the fan platform service server 200, and the external server 300 that implement the fandom-index measurement and reward system 1000 will be described in detail with reference to the attached drawings.

### Fan Terminal 100

The fan terminal 100 according to an embodiment of the present disclosure may be a computing device having a fan platform application (hereinafter, an “application”) installed that provides the fandom-index measurement and reward service.

Specifically, from a hardware point of view, the fan terminal 100 may include a mobile-type computing device 100-1 and/or a desktop-type computing device 100-2 in which the application is installed.

Herein, the mobile-type computing device 100-1 may be a mobile device such as a smartphone or tablet PC in which the application is installed.

For example, the mobile-type computing device 100-1 may include a smartphone, a mobile phone, a digital broadcasting terminal 100, a personal digital assistant (PDA), a portable multimedia player (PMP), and a tablet PC.

In addition, the desktop-type computing device 100-2 may include a device installed with a program to execute the digital item provision service based on wired/wireless communication such as a fixed-type desktop PC, a laptop computer, and a personal computer such as an ultrabook in which the application is installed.

In addition, according to an embodiment, the fan terminal 100 may further include a predetermined server computing device that provides a fandom-index measurement and reward service environment.

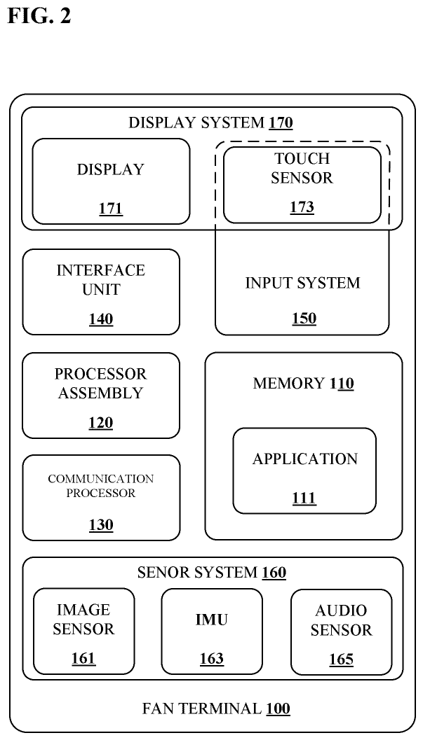

FIG. 2 is an internal block diagram of the fan terminal 100 according to an embodiment of the present disclosure.

Referring to FIG. 2, from a functional point of view, the fan terminal 100 may include a memory 110, a processor assembly 120, a communication module 130, an interface module 140, an input system 150, a sensor system 160, and a display system 170. These components may be configured to be included within a housing of the fan terminal 100.

Specifically, the memory 110 may store an application 111, and the application 111 may store one or more of various application programs, data, and commands for providing the fandom-index measurement and reward service environment.

In other words, the memory 110 may store commands and data used for creating the fandom-index measurement and reward service environment.

In addition, the memory 110 may include a program area and a data area.

Herein, the program area according to an embodiment may be linked between an operating system (OS) for booting the fan terminal 100 and functional elements, and the data area may store data generated according to the use of the fan terminal 100.

In addition, the memory 110 may include at least one non-transitory computer-readable storage medium or a temporary computer-readable storage medium.

For example, the memory 110 may be various storage devices, such as a ROM, an EPROM, a flash drive, and a hard drive; and may be a web storage performing a storage function of the memory 110 on the Internet.

The processor assembly 120 may include at least one processor capable of executing commands of the application 111 stored in the memory 110 to perform various tasks for creating the fandom-index measurement and reward service environment.

In an embodiment, the processor assembly 120 may control the overall operation of components through the application 111 of the memory 110 in order to provide the fandom-index measurement and reward service.

The processor assembly 120 may be a system-on-chip (SOC) suitable for the fan terminal 100 that includes a central processing unit (CPU) and/or graphics processing unit (GPU), may execute the OS and/or an application program stored in the memory 110, and control each component mounted on the fan terminal 100.

In addition, the processor assembly 120 may communicate with each component internally through a system bus and may include one or more predetermined bus structures including a local bus.

In addition, the processor assembly 120 may be implemented by using at least one of application-specific integrated circuits (ASICs), digital signal processors (DSPs), digital signal processing devices (DSPDs), programmable logic devices (PLDs), field programmable gate arrays (FPGAs), controllers, micro-controllers, microprocessors, or electric units for performing other functions.

The communication module 130 may include one or more devices for communicating with an external device. The communication module 130 may communicate through a wireless or wired network.

In detail, the communication module 130 may communicate with the fan terminal 100 storing a content source for implementing the fandom-index measurement and reward service environment, and may communicate with various user input components such as a controller receiving a user input.

In an embodiment, the communication module 130 may transmit/receive various pieces of data related to the fandom-index measurement and reward service to/from another fan terminal 100, and/or an external server.

This communication module 130 may wirelessly transmit and receive data with at least one of a base station, an external fan terminal 100, or an arbitrary server on a mobile communication network built through a communication device capable of performing technical standards or communication methods (for example, LTE (Long Term Evolution), LTE-A (Long Term Evolution-Advanced), 5G NR (New Radio), and WIFI) for mobile communication.

The sensor system 160 may include various sensors such as an image sensor 161, a position sensor (IMU) 163, an audio sensor 165, a distance sensor, a proximity sensor, and a contact sensor.

Herein, the image sensor 161 may capture an image and/or a video of a physical space around the fan terminal 100.

In an embodiment, the image sensor 161 may capture and acquire various images and/or videos related to the fandom-index measurement and reward service.

In addition, the image sensor 161 may be disposed on the front or/and rear side of the fan terminal 100 to acquire an image by capturing the disposed direction side, and may capture a physical space through a camera disposed toward the outside of the fan terminal 100.

The image sensor 161 may include an image sensor device and a video processing module. Specifically, the image sensor 161 may process a still image or a moving image obtained by an image sensor device (for example, CMOS or CCD).

In addition, the image sensor 161 may process a still image or a moving image obtained through the image sensor device using an image processing module to extract necessary information, and transmit the extracted information to a processor.

The image sensor 161 may be a camera assembly including at least one or more cameras. The camera assembly may include a general camera that captures a visible light band, and may further include a special camera such as an infrared camera or a stereo camera.

In addition, the aforementioned image sensor 161 may be operated while being included in the fan terminal 100 according to an embodiment, or may be included in an external device (for example, an external server) to operate through interworking based on the aforementioned communication processor 130 and/or interface unit 140.

The IMU 163 may sense at least one of motion or acceleration of the fan terminal 100. For example, the IMU 163 may include a combination of various position sensors such as an accelerometer, a gyroscope, and a magnetometer.

In addition, the IMU may interwork with the position communication processor 130 such as GPS of the communication module 130 to recognize spatial information on the physical space around the fan terminal 100.

The audio sensor 165 may recognize a sound around the fan terminal 100.

In detail, the audio sensor 165 may include a microphone capable of sensing a speech input of a user using the fan terminal 100.

In an embodiment, the audio sensor 165 may receive speech data necessary for the fandom-index measurement and reward service.

The interface module 140 may communicatively connect the fan terminal 100 with one or more other devices. Specifically, the interface module 140 may include wired and/or wireless communication devices that are compatible with one or more different communication protocols.

The fan terminal 100 may be connected to various input/output devices through the interface module 140.

For example, the interface module 140 may be connected to an audio output device such as a headset port or a speaker to output audio.

Although it has been described as an example that the audio output device is connected through the interface module 140, an embodiment in which the audio output device is installed in the fan terminal 100 may also be included.

In addition, for example, the interface module 140 may be connected to an input device such as a keyboard and/or mouse to acquire user input.

This interface module 140 may include at least one of a wired/wireless headset port, an external charger port, a wired/wireless data port, a memory card port, a port for connecting a device equipped with an identification module, an audio input/output (I/O) port, a video I/O port, an earphone port, a power amplifier, an RF circuit, a transceiver or other communication circuits.

The input system 150 may sense a user input (for example, a gesture, a speech command, operation of a button, or other type of input) related to the fandom-index measurement and reward service.

Specifically, the input system 150 may include a predetermined button, a touch sensor, and/or an image sensor 161 that receives a user motion input.

In addition, the input system 150 may be connected to an external controller through the interface module 140 to receive a user input.

The display system 170 may output various pieces of information related to the fandom-index measurement and reward service as a graphic image.

In an embodiment, the display system 170 may display various pieces of data based on fan activities, fandom-index information, ranking information, reward-related information, business insights, and/or various user interfaces.

Such display may include at least one of a liquid crystal display (LCD), a thin film transistor-liquid crystal display (TFT LCD), an organic light-emitting diode (OLED), and a flexible display, a 3D display, or an electronic ink display (e-ink display).

The above components may be disposed within the housing of the fan terminal 100, and a user interface may include a touch sensor 173 on a display 171 configured to receive a user touch input.

In detail, the display system 170 may include the display 171 that outputs an image and the touch sensor 273 that senses a user touch input.

For example, the display 171 may form an overlaid structure with the touch sensor 173 or integrally formed to be implemented as a touch screen. Such a touch screen may function as a user input unit that provides an input interface between the fan terminal 100 and the user, and may provide an output interface between the fan terminal 100 and the user.

In addition, according to an embodiment, the fan terminal 100 may further perform at least a portion of functional operations performed by the fan platform service server 200 and/or the external server 300, which will be described later.

### Fan Platform Service Server 200

The fan platform service server 200 according to an embodiment of the present disclosure may perform a series of processes for providing the fandom-index measurement and reward service.

In detail, in an embodiment, the fan platform service server 200 may provide the fandom-index measurement and reward service by exchanging data required for a fandom-index measurement and reward process to be driven by an external device such as the fan terminal 100 with the external device.

In more detail, in an embodiment, the fan platform service server 200 may provide an environment in which the application 111 may operate in an external device (in an embodiment, the mobile-type computing device 100-1 and/or the desktop-type computing device 100-2).

To this end, the fan platform service server 200 may include application programs, data and/or commands for the application 111 to operate, and may transmit and receive various pieces of data based thereon with the external device.

In addition, in an embodiment, the fan platform service server 200 may collect fan activity data based on a fan platform service.

As an example, the fan platform service may mean an online platform service that supports various fan activities, including promotional activities, purchasing activities, and/or participation activities online and offline, through connections between fans and artists (and/or artist groups).

In addition, the fan activity data may refer to information that specifies the attributes of fan activities performed by each fan user for a predetermined artist (and/or artist group). A detailed explanation thereof will be provided in a fandom-index measurement and reward method below.

In addition, in an embodiment, the fan platform service server 200 may collect the fan activity data based on a predetermined external service by linking with the external server 300.

For example, the external service may be an SNS platform provision service, a streaming platform provision service, and/or a video platform provision service.

In addition, in an embodiment, the fan platform service server 200 may determine a fandom-index based on the fan activity data collected as described above.

Herein, the fandom-index may mean information that collates and matches the fan activity data based on an internal service (in an embodiment, a fan platform service) and the fan activity data based on an external service, and stores and manages the same for each fan user.

In addition, in an embodiment, the fan platform service server 200 may provide ranking information among a plurality of fan users for a predetermined artist (and/or artist group) based on the determined fandom-index.

In addition, in an embodiment, the fan platform service server 200 may provide rewards to predetermined fan users based on the ranking based on the fandom-index.

In addition, in an embodiment, the fan platform service server 200 may update the value-price for a predetermined NFT based on the fandom-index.

In addition, in an embodiment, the fan platform service server 200 may provide business insights based on the fandom-index.

Herein, the business insight may mean information that provides various pieces of statistical data by processing various pieces of data based on a plurality of fandom-indices determined as above according to a predetermined method.

In addition, in an embodiment, the fan platform service server 200 may store and manage various application programs, commands, and/or data for implementing the fandom-index measurement and reward service.

As an example, the fan platform service server 200 may store and manage at least one or more of fan activity data, fandom-index, ranking information, reward-related information, NFT-related data, business insights, and/or user interfaces.

However, the functional operations that the fan platform service server 200 may perform in an embodiment of the present disclosure are not limited to those described above, and other functional operations may be further performed.

Referring further to FIG. 1, in an embodiment, the fan platform service server 200 as described above may be implemented as a predetermined computing device including at least one processor module 210 for data processing, at least one communication module 220 for data exchange with an external device, and at least one memory module 230 for storing various application programs, data, and/or commands for providing the fandom-index measurement and reward service.

Herein, the memory module 230 may store one or more of an operating system (OS), various application programs, data, or commands for providing the fandom-index measurement and reward service.

In addition, the memory module 230 may include the program area and the data area.

Herein, the program area according to an embodiment may be linked between the OS for booting a server and functional elements, and the data area may store data generated according to the use of the server.

In an embodiment, the memory module 230 may be various storage devices, such as a ROM, a RAM, an EPROM, a flash drive, and a hard drive, and may be a web storage performing a storage function of the memory module 230 on the Internet.

In addition, the memory module 230 may be a detachable recording medium on a server.

The processor module 210 may control the overall operation of each unit to implement the fandom-index measurement and reward service.

The processor module 210 may be the SOC suitable for the server that includes the CPU and/or GPU, may execute the OS and/or an application program stored in the memory module 230, and control each component mounted on the server.

In addition, the processor module 210 may communicate with each component internally through a system bus and may include one or more predetermined bus structures including a local bus.

In addition, the processor module 210 may be implemented by using at least one of the ASICS, DSPs, DSPDs, PLDs, FPGAs, controllers, micro-controllers, microprocessors, or electric units for performing other functions.

In the above description, it has been described that the fan platform service server 200 according to an embodiment of the present disclosure performs the functional operation as described above. However, according to an embodiment, various embodiments may be possible, such as performing at least a portion of the functional operation performed by the fan platform service server 200 (for example, the fan terminal 100), and further performing at least a portion of the functional operation performed in the external device in the fan platform service server 200.

### External Server 300

The external server 300 according to an embodiment of the present disclosure may provide predetermined data that may be utilized on the fandom-index measurement and reward service to the fan terminal 100 and/or the fan platform service server 200.

In detail, in an embodiment, the external server 300 may be a server that implements an external service (for example, an SNS platform provision service, a streaming platform provision service, and/or a video platform provision service) that may support fan activities (in other words, various online/offline promotional activities, purchasing activities, and/or participation activities through connections between fans and artists (and/or artist groups) in an embodiment).

For example, such external servers 300 may include the SNS platform provision server, the streaming platform provision servers, and/or the video platform provision server.

Referring further to FIG. 1, in an embodiment, the external server 300 as above may include at least one data transmission and reception unit 310, a processor unit 320, and a database 330.

First, the data transmission and reception unit 310 according to an embodiment may transmit and receive various pieces of data for supporting the fandom-index measurement and reward service through the network 400 in conjunction with an external device (for example, the fan terminal 100 and/or the fan platform service server 200).

As an example, the data transmission and reception unit 310 may transmit and receive external service-based fan activity data with the fan terminal 100 and/or the fan platform service server 200 through a network.

In addition, the database 330 according to an embodiment may store and manage various pieces of data for supporting the fandom-index measurement and reward service.

In an embodiment, the database 330 may store and manage at least one of the OS, various application programs, data, and commands for implementing a predetermined external service, and may store and manage the fan activity data based on the external service.

These databases 330 may be various storage devices, such as a ROM, a RAM, an EPROM, a flash drive, and a hard drive, and may also be web storage performing a storage function of the database 330 on the internet.

In addition, the processor unit 320 according to an embodiment may control the overall operation of each component described above for implementing the fandom-index measurement and reward service.

The processor unit 320 may be implemented using at least one of the ASICs, the DSPs, the DSPDs, the PLDs, the FPGAs, controllers, micro-controllers, microprocessors, or electric units for performing other functions.

### Fandom-Index Measurement and Reward Method

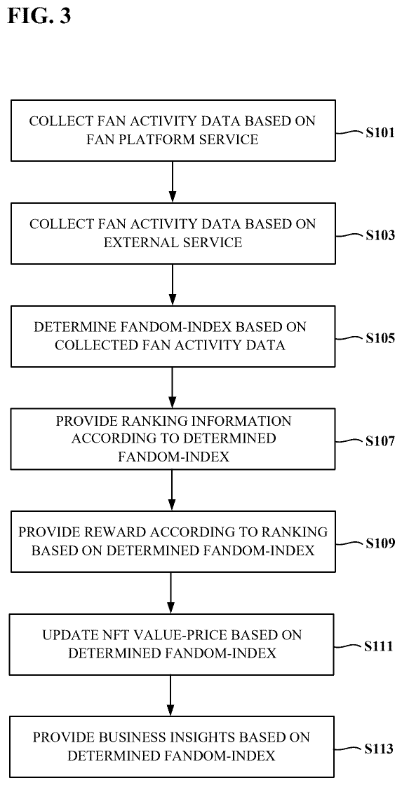

Hereinafter, a method for determining a fandom-index and providing a reward by the fandom-index measurement and reward system 1000 (hereinafter, a “fandom-index system”) according to an embodiment of the present disclosure will be described in detail with reference to the attached FIGS. 3 to 8.

FIG. 3 is a flowchart illustrating a fandom-index measurement and reward method according to an embodiment of the present disclosure.

Referring to FIG. 3, in an embodiment of the present disclosure, the fandom-index system may collect the fan activity data based on a fan platform service (S101).

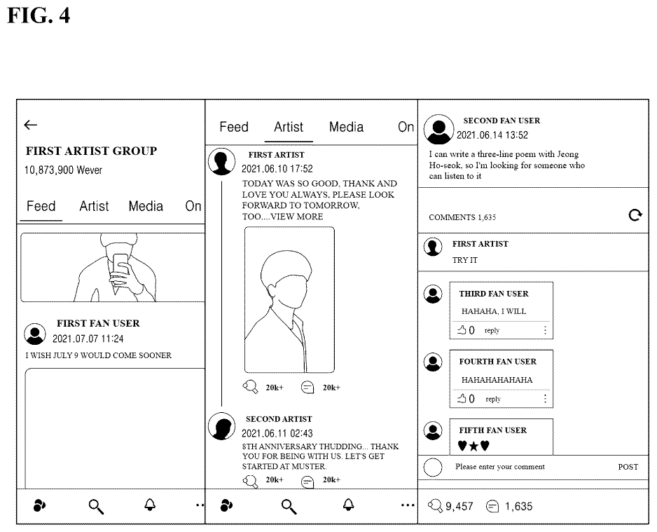

FIG. 4 is an example showing a fan platform service according to an embodiment of the present disclosure.

Referring to FIG. 4, herein, the fan platform service according to an embodiment may mean an online platform service that supports various fan activities, including promotional activities, purchasing activities, and/or participation activities online and offline, through connections between fans and artists (and/or artist groups (hereinafter, a “group”)).

For example, the fandom-index system may support fans to subscribe to or follow a predetermined artist (and/or group) and perform various fan activities (for example, promotional activities, purchasing activities, and/or participation activities) related to the artist (and/or group) through the fan platform service.

In this connection, in an embodiment, the fandom-index system may collect data (in other words, the fan activity data) that specifies the fan activities performed in order to provide a predetermined reward by reflecting the achievements (contributions) according to various fan activities performed on the fan platform service as described above.

In detail, the fan activity data according to an embodiment may mean information that specifies the attributes of fan activities performed by each fan user for a predetermined artist (and/or group). Such fan activity data may be matched to each corresponding fan user and stored and managed.

In detail, in an embodiment, the fan activity data may specify attributes of the fan activity based on parameter information about the activity target, activity section, activity time, activity type, activity response, and/or activity level for the performed fan activity.

Specifically, the activity target information of the fan activity data may be information that specifies the artist (and/or group) that is the target of the fan activity.

In addition, the activity section information of the fan activity data may be information specifying the field in which the fan activity is performed, such as a specific album, a specific tour, or a specific work.

In addition, the activity time information of the fan activity data may be information specifying the time at which the fan activity was performed, and may be, for example, the date, time, period, and/or cycle of the fan activity performance.

In addition, the activity type information of the fan activity data may be information that specifies the specific performance history of the fan activity.

For example, the types of activities may include 1) SNS activities (for example, writing/reading posts based on a predetermined platform, writing/reading content, clicking on advertising banners, and/or attendance checks), 2) product purchase activities (for example, purchasing online albums/goods and/or authenticating offline albums/goods after purchase (for example, QR code authentication), 3) mission activities (for example, performing a predetermined mission to derive/attract fans for a new artist (and/or group), 4) survey activities (for example, participating in a survey to check satisfaction with MD, content, and/or concerts), and/or 5) fan meeting activities (for example, participating in online/offline fan meetings), etc.

In addition, the activity response information of the fan activity data may be information indicating the response of other users (including artists and/or groups) to the fan activity, and may be, for example, the number of likes, number of dislikes, number of subscribers, and/or number of reports by other users.

In addition, the activity level information of the fan activity data may be information that measures the degree to which fan activity was performed (in other words, fan activity level) and its contribution (achievement) and quantifies the same.

In other words, in an embodiment, the activity level information may be information that converts the activity level for fan activities performed by a predetermined artist (and/or group) for each fan user into a numerical value.

In this connection, in an embodiment, the fandom-index system may grant activity points preset for each predetermined factor (for example, activity type, detailed items within activity type, activity response, and/or activity time) in order to create the activity level information.

Herein, the activity points according to an embodiment may be information that presets the score to be increased or decreased as each fan activity is performed when calculating the activity level based on the performed fan activities.

In detail, in an embodiment, the fandom-index system may 1) set activity points by activity type.

Specifically, the fandom-index system may grant preset activity points for each activity type, including a first activity type (for example, SNS activity), a second activity type (for example, product purchase activity), a third activity type (for example, mission activity), a fourth activity type (for example, survey activity), and/or a fifth activity type (for example, fan meeting activity).

For example, the fandom-index system may preset activity points for each activity type, such as the first activity type: +10 activity points, the second activity type: +20 activity points, . . . , Nth activity type: +30 activity points.

In addition, in an embodiment, the fandom-index system may 2) preset activity points for each detailed item within the activity type.

In detail, in an embodiment, the fandom-index system may grant preset activity points for each detailed item within each activity type, including detailed items within the first activity type (for example, SNS activity) (for example, writing/viewing a post based on a predetermined platform, writing/viewing content, clicking on an advertising banner, and/or checking attendance), detailed items within the second activity type (for example, product purchase activity) (for example, online goods purchase and/or offline goods purchase post-authentication (for example, QR code authentication)), detailed items within the third activity type (for example, mission activity) (for example, performing a predetermined mission to derive/attract fans for a new artist (and/or group)), detailed items within the fourth activity type (for example, survey activity) (for example, participating in a survey to check satisfaction with MD, content, and/or concert), and/or detailed items within the fifth activity type (for example, fan meeting activity) (for example, participating in an online/offline fan meeting).

In this connection, in an embodiment, the fandom-index system may classify the detailed items into one of the categories of basic actions or advanced actions, and preset activity points according to the classified category.

Herein, the basic action according to an embodiment may include fan activities that do not require a separate creative cost (for example, subscribing and/or liking), and the advanced action may include fan activities that require a separate creative cost (for example, uploading content (for example, video, feedback, and/or text).

In detail, in an embodiment, the fandom-index system may preset a predetermined activity point by matching each of at least one detailed item classified as the basic action.

For example, the fandom-index system may grant activity points for each detailed item within the basic action, such that when a fan user performs a subscription activity, +1 activity point is calculated, and when the fan user performs a liking activity, +1 activity point is calculated.

In addition, in an embodiment, the fandom-index system may preset a predetermined activity point by matching each of at least one detailed item classified as the advanced action.

In this connection, in an embodiment, the fandom-index system may set activity points according to the content upload based on the amount of content uploaded as the advanced action.

In detail, in an embodiment, when a fan user uploads predetermined content, the fandom-index system may analyze the data amount and/or resolution of the uploaded content to compute the content amount for the content.

In addition, the fandom-index system may set activity points granted according to content upload in proportion to the content amount computed above.

In addition, in an embodiment, the fandom-index system may 3) preset activity points based on activity response.

In detail, in an embodiment, the fandom-index system may preset a predetermined activity point for each activity response, including a first activity response (for example, like), a second activity response (for example, dislike), a third activity response (for example, subscribe), and/or a fourth activity response (for example, report).

For example, the fandom-index system may preset activity points for each activity response, such as the first activity response: +1 activity point, the second activity response: −1 activity point, the third activity response: +2 activity points, and/or the fourth activity response: −10 activity points.

As such, the fandom-index system may calculate a more reasonable activity level by measuring the activity level performed by fan users according to detailed criteria, thereby considering in detail the contribution (value) and required effort of the performed fan activity, and may provide customized rewards according to the characteristics of the fan activity history performed in the future.

In addition, in an embodiment, the fandom-index system may 4) preset activity points according to the activity time.

In detail, in an embodiment, the fandom-index system may preset activity points according to the time of activity so that the activity points granted increase the closer it is to a predefined period or recent time.

For example, the fandom-index system may be preset to: +10 for activity points for fan activities performed at a first point in time, and +20 for activity points for fan activities performed at a second point in time after the first point in time.

The fandom-index system that grants activity points preset for each predetermined factor (such as activity type, detailed item within activity type, activity response, and/or activity time) as described above may create the activity level information by adding up the activity points corresponding to the fan activity data collected later.

In other words, in an embodiment, the fandom-index system may create the activity level information by adding up the activity points corresponding to the collected fan activity data and quantifying the fan activity level according to the fan activity data.

In this connection, in an embodiment, the fandom-index system may compute the activity level information (hereinafter, “sub-activity level information”) for each parameter by dividing the activity level information into each parameter in the collected fan activity data (in other words, activity target, activity section, activity time, activity type, activity response, and/or activity level in an embodiment), and may create the activity level information according to the fan activity data by adding up each of the calculated sub-activity level information.

In addition, in an embodiment, the fandom-index system may compute the activity level information by dividing the same into a predetermined period.

In detail, in an embodiment, the fandom-index system may calculate the activity level information for a predetermined period, such as daily, weekly, monthly, yearly, and/or for a designated period according to user settings (for example, a specific event period).

In more detail, the fandom-index system may divide and accumulate the activity level according to fan activities performed by the corresponding fan user according to at least one criterion during the predetermined period.

In addition, the fandom-index system may determine the activity level information on fan activities performed during each period based on the accumulated activity level for each period.

Thus, the fandom-index system may support easy confirmation of fan user activity status or achievements according to a desired period.

In addition, in an embodiment, the fandom-index system may collect the fan activity data based on external services (S103).

In other words, in an embodiment, the fandom-index system may collect the fan activity data on fan activities performed through the external services (for example, SNS platform service, streaming platform service, and/or video platform service) in order to provide a predetermined reward by reflecting achievements (contributions) according to various fan activities performed on the external services.

Hereinafter, any explanation that overlaps with the above may be summarized or omitted.

In detail, in an embodiment, the fandom-index system may collect fan activity external data based on 1) an external activity input interface that may register fan activity data based on an external service (hereinafter, “fan activity external data”).

In more detail, in an embodiment, the fandom-index system may provide the external activity input interface to a fan user based on the fan terminal 100.

In addition, in an embodiment, the fandom-index system may acquire the fan activity external data based on a fan user input to the external activity input interface provided above.

As an example, the fandom-index system may acquire external service platform information (for example, external service platform name and/or site address), activity authentication information (for example, activity page link and/or screenshot), activity target, activity section, activity time, and/or activity type information through a fan user input based on the external activity input interface, and may collect the fan activity external data based on the acquired input.

Alternatively, in an embodiment, the fandom-index system may access a corresponding external service platform based on the external service platform information and/or the activity authentication information, and may collect relevant fan activity external data by crawling on the accessed external service platform. In an embodiment of the present disclosure, the algorithm for performing the crawling is not limited or restricted, and the crawling operation as described above may be performed by utilizing various known algorithms.

In another embodiment, the fandom-index system may 2) automatically receive and collect the fan activity external data based on an external service implemented by the external server 300 from the external server 300 without separate registration of a fan user by conducting an information provision consent process in conjunction with a predetermined external server 300.

In detail, in an embodiment, the fandom-index system may acquire a fan user input setting whether to consent to automatically providing fan activity external data based on the predetermined external service to the fan platform service server 200.

In addition, when a fan user input consenting to automatically provide the fan activity external data to the fan platform service server 200 is acquired, the fandom-index system may automatically receive and collect, from the external server 300 to the fan platform service server 200, the fan activity external data according to the performed fan activity when the fan activity of the fan user is performed on the external service.

Hereinbefore, the embodiments have been described separately as described above for effective explanation, but various embodiments may be possible, such as at least some of the embodiments may be organically combined and operated with each other.

As such, the fandom-index system collects not only internal fan activity data acquired based on the fan platform service described above, but also fan activity data (in an embodiment, fan activity external data) based on fan activities performed on various external services (for example, SNS platform provision service, streaming platform provision service, and/or video platform provision service, etc.), thereby collecting all of the various promotional, purchasing, and/or participation activities performed by fan users for a predetermined artist (and/or group) over a wider area, thereby enabling more accurate and complete understanding of actual activity history information performed by the fan users.

In addition, in an embodiment, the fandom-index system may determine the fandom-index based on the collected fan activity data (S105).

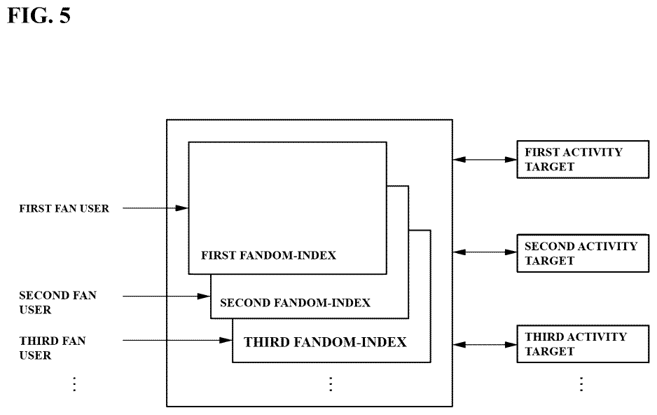

FIG. 5 is an example showing a fandom-index according to an embodiment of the present disclosure.

In detail, referring to FIG. 5, in an embodiment, the fandom-index system may determine a fandom-index for each fan user based on the fan activity data collected as described above and the fan activity external data (hereinafter, “fan activity integrated data”).

In other words, herein, the fandom-index according to an embodiment may mean information that collates and matches fan activity data based on an internal service (in an embodiment, a fan platform service) and fan activity external data based on an external service, and stores and manages the same for each fan user.

In this connection, depending on an embodiment, the fandom-index may be stored and managed by matching the same to an artist (and/or group) that is the target of activity in the corresponding fan activity integrated data.

In more detail, in an embodiment, the fandom-index system may determine a first fandom-index, which is a fandom-index for a first fan user, based on first comprehensive activity target information encompassing internal/external activity targets of the first fan user, first comprehensive activity section information encompassing internal/external activity sections of the first fan user, first comprehensive activity time information encompassing internal/external activity times of the first fan user, first comprehensive activity type information encompassing internal/external activity types of the first fan user, first comprehensive activity response information encompassing internal/external activity responses of the first fan user, and first comprehensive activity level information encompassing internal/external activity levels of the first fan user.

For example, the fandom-index system may determine the first fandom-index of the first fan user by encompassing the first comprehensive activity target information such as ‘internal service activity target: first artist, external service activity target: first group to which the first artist belongs’, the first comprehensive activity section information such as ‘internal service activity section: first album, external service activity section: first album’, and the first comprehensive activity time information such as ‘internal service activity time: first period, external service activity time: first period’.

In other words, in an embodiment, the fandom-index system may determine the fandom-index for each fan user by collating fan activity data based on all fan activities performed by each fan user on internal/external services.

As such, the fandom-index system may easily divide, organize and manage various fan activity histories and achievements performed across a wide range of activities encompassing the fan platform services and predetermined external services by fan user. Thus, the fan activity characteristics of the corresponding fan user may be later derived and appropriate rewards may be provided accordingly.

In addition, the fandom-index system may divide, organize and manage various fan activity histories and achievements by predetermined activity target (in other words, artist and/or group in an embodiment), and accordingly, may analyze numerous fan activities related to the corresponding activity target at once and utilize the same in various ways (for example, providing statistics).

In addition, in an embodiment, the fandom-index system may provide ranking information according to the determined fandom-index (S107).

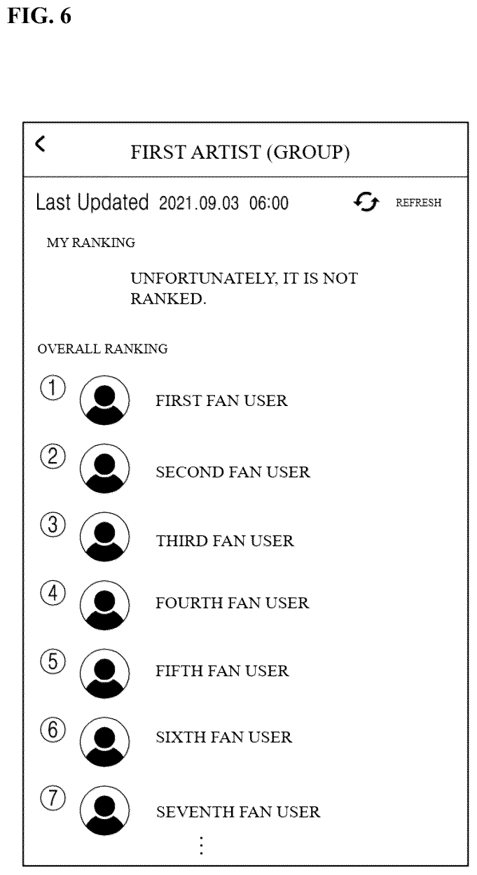

FIG. 6 is an example of providing ranking information according to an embodiment of the present disclosure.

In other words, referring to FIG. 6, in an embodiment, the fandom-index system may provide the ranking information among a plurality of fan users for a predetermined activity target (in other words, a predetermined artist (and/or group)) based on the determined fandom-index.

In detail, in an embodiment, the fandom-index system may provide the ranking information indicating a sequence (rank) among a plurality of fan users for a predetermined activity target based on activity level information (comprehensive activity level information) determined for each of the plurality of fan users within the fandom-index.

In more detail, in an embodiment, the fandom-index system may provide the ranking information by sequentially listing a plurality of fan users based on the activity level information that quantifies the fan activity of each of the plurality of fan users for a predetermined activity target.

For example, when the activity level of the first fan user is 300 points, the activity level of the second fan user is 400 points, and the activity level of the third fan user is 500 points, the fandom-index system may provide ranking information listing the first to third fan users in descending order.

In this connection, in an embodiment, the fandom-index system may provide ranking information for a predetermined period by using the activity level information for each of the plurality of fan users calculated for a predetermined period, such as daily, weekly, monthly, yearly, and/or for a designated period according to user settings (for example, a specific event period).

In other words, the fandom-index system may provide daily ranking information, weekly ranking information, yearly ranking information, and/or designated period ranking information based on activity level information within the fandom-index for each of the plurality of fan users.

In addition, in an embodiment, the fandom-index system may provide updated ranking information based on the activity level information of a plurality of fan users that is updated at a predetermined cycle (for example, daily, weekly, monthly, yearly, and/or designated period).

Accordingly, the fandom-index system may grant predetermined stimulation or motivation to fan users to further their fan activities by checking the ranking information provided, and may provide and present a reasonable basis for rewards for fan activities provided in the future.

In addition, in an embodiment, the fandom-index system may provide a reward based on a ranking based on the determined fandom-index (S109).

In detail, in an embodiment, the fandom-index system may provide a reward to at least some of the plurality of fan users based on a ranking determined based on the activity level information within the fandom-index of the plurality of fan users.

In more detail, in an embodiment, the fandom-index system may: 1) provide a basic reward according to the ranking.

Specifically, in an embodiment, the fandom-index system may detect at least one fan user who satisfies a predetermined criterion (for example, top 10% or top 10 users in ranking).

In addition, the fandom-index system may provide a predetermined basic reward by linking with the fan terminal 100 of the detected fan user.

For example, the fandom-index system may provide, as the basic reward, a reward based on a leveling system (for example, level up, increase in level ranking, and/or provision of emblems), priority rights to participate in online/offline events (for example, fan meetings and/or concerts), and/or virtual currency available on the fan platform service.

As such, the fandom-index system may encourage more active fan activities by providing a predetermined reward to fan users with relatively high fan activity, thereby increasing economic benefits and reducing promotional costs for artists (and/or groups), thereby inducing various benefits that come with increased fan activity.

In an embodiment, the fandom-index system may 2) provide a non-fungible token (NFT) reward according to the ranking.

Herein, the NFT reward according to an embodiment may mean a reward provided based on an NFT, which is a unique digital file type registered on a blockchain.

For reference, the NFT refers to a virtual token that proves the ownership of a digital asset using blockchain technology, and may be a type of virtual certificate of authenticity used to indicate its unique originality and ownership by including an address indicating a digital file such as a certain image or video in a token. The NFT has the advantage that its economic value may gradually increase over time.

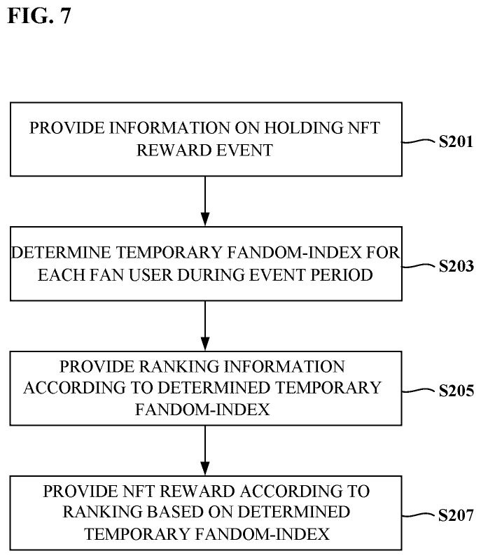

FIG. 7 is a flowchart illustrating a method for providing an NFT (non-fungible token) reward according to an embodiment of the present disclosure.

In detail, referring to FIG. 7, in an embodiment, the fandom-index system may provide information on holding an event (hereinafter, “NFT event”) that provides an NFT reward (S201).

In other words, in an embodiment, the fandom-index system may measure the activity level information of a plurality of fan users within a predetermined designated period (herein, a specific event period) and provide NFT event hosting information that provides the NFT reward to at least some of the plurality of fan users based on the measured activity level information.

Herein, the NFT event holding information according to an embodiment may include target artist (and/or group) information, event period information, and/or activity level calculation standard information.

In this connection, the activity level calculation standard information according to an embodiment may include activity point information preset for each of the aforementioned predetermined factors (such as activity type, detailed items within the activity type, and/or activity response) and/or whether existing activity level information accumulated before the event period is linked. A detailed explanation of whether the existing activity level information is linked will be provided later.

In an embodiment, the fandom-index system may provide the NFT event holding information, such as the above, to a plurality of fan users by using fan terminals 100 for each fan user.

In addition, in an embodiment, the fandom-index system may determine a temporary fandom-index for each fan user according to the event period (S203).

Herein, the temporary fandom-index according to an embodiment may mean a fandom-index for each fan user determined based on integrated fan activity data collected during a predetermined designated period (herein, the event period).

In detail, in an embodiment, the fandom-index system may determine the temporary fandom-index for each fan user by collating fan activity data (in other words, integrated fan activity data in an embodiment) based on all fan activities performed by each fan user on internal/external services during the predetermined designated period (herein, the event period).

In this connection, in an embodiment, the fandom-index system may first set an initial activity level value according to whether the existing activity level information is linked in order to calculate comprehensive activity level information (hereinafter, temporary comprehensive activity level information) within the temporary fandom-index.

Herein, the linkage of the existing activity level information according to an embodiment may be information for determining whether to reflect the existing activity level accumulated for a fan user prior to the designated period (herein, the event period) when calculating the temporary comprehensive activity level information.

In other words, in an embodiment, the fandom-index system may set the initial activity level value in different ways depending on whether the existing activity level information is linked.

This may be to include a functional device to prevent a situation where an appropriate reward may not be provided to fan users who have been performing continuous fan activities when the accumulated fan activity levels prior to the relevant event period is completely excluded.

In detail, in an embodiment, in the case of an event that links the existing activity information, the fandom-index system may set the initial activity level value by reflecting the activity level accumulated before the designated period (herein, the event period) according to a predetermined application condition.

As an example, the fandom-index system may set the initial activity level value by switching at least a portion of the accumulated existing activity level to the initial activity level value according to a user setting.

For example, when there is an existing activity level of 10,000 points, the fandom-index system may switch at least a portion of the 10,000 points (for example, 5,000 points) to the initial activity level value according to user settings. In other words, in an embodiment, the fandom-index system may switch the points deducted from the existing activity level into the initial activity level value.

In this connection, in an embodiment, the fandom-index system may limit the point switching to be performed within a range of a preset maximum switching value (for example, 1,000 points).

Alternatively, in an embodiment, the fandom-index system may set an initial activity level value according to the existing activity level based on the initial activity level value set for each predetermined activity level section.

In detail, in an embodiment, the fandom-index system may preset an initial activity level value that matches each predetermined activity level section.

For example, the fandom-index system may preset the initial activity level value matching the first activity level section (for example, 0 to 100 point section) to 50 points, the initial activity level value matching the second activity level section (for example, 101 to 500 point section) to 300 points, . . . , the initial activity level value matching the Nth activity level section to 1000 points.

In addition, in an embodiment, the fandom-index system may detect an activity level section to which the existing activity level belongs among the predetermined activity level sections.

In addition, in an embodiment, the fandom-index system may set an initial activity level value matching the detected activity level section as an initial activity level value calculated by reflecting the existing activity level.

Hereinbefore, the embodiments have been described separately as described above for effective explanation, but various embodiments may be possible, such as at least some of the embodiments may be organically combined and operated with each other.

As such, the fandom-index system may set an initial activity level value by reflecting the accumulated fan activity level before the relevant event period according to a predetermined application conditions, thereby granting higher value to fan users who have been performing continuous fan activities before the event period and providing appropriate rewards therefor in the future.

In an embodiment, the fandom-index system may set the initial activity level value to ‘0’ regardless of the activity level accumulated before the designated period (herein, the event period) in the case of an event that is not linked to the existing activity level information.

In addition, the fandom-index system that sets the initial activity level value as described above in an embodiment may determine a temporary fandom-index for each fan user based on the integrated fan activity data collected during the designated period (herein, the event period).

In this connection, in an embodiment, when calculating temporary comprehensive activity level information within the temporary fandom-index, the fandom-index system may calculate the temporary comprehensive activity level information by adding up all activity points according to the initial activity level value set as described above and the activity level information collected during the designated period (herein, the event period).

For example, when the initial activity level value is “1,000 points” and the activity point value according to the activity level information collected during the designated period (herein, the event period) is “30,000 points,” the fandom-index system may calculate “31,000 points,” which is the sum of the activity points, as the temporary comprehensive activity information.

In this connection, depending on an embodiment, the fandom-index system may compute the temporary comprehensive activity level information in a manner that grants greater weight to fan activities performed more recently within the designated period (herein, the event period).

In detail, in an embodiment, the fandom-index system may set a weight that increases proportionally as getting closer to a recent time within the designated period (herein, the event period).

In addition, the fandom-index system may perform a predetermined arithmetic operation (for example, multiplication arithmetic operation) by applying the set weight to each fan activity performed within the designated period (herein, the event period).

Thus, the fandom-index system may compute temporary comprehensive activity level information based on a method in which more recent fan activities are granted more points (scores).

Accordingly, the fandom-index system may encourage active and vibrant fan activities even at the end of the event period.

In addition, in an embodiment, the fandom-index system may provide ranking information according to the determined temporary fandom-index (S205).

In detail, in an embodiment, the fandom-index system may provide ranking information indicating a sequence (rank) among a plurality of fan users based on activity level information in a temporary fandom-index determined for the plurality of fan users for a predetermined activity target (in other words, a predetermined artist (and/or group)) during the designated period (herein, the event period).

In this connection, in an embodiment, the fandom-index system may provide the ranking information by updating the same at a predetermined cycle (for example, daily, weekly, monthly, yearly, and/or designated period).

In addition, in an embodiment, the fandom-index system may provide ranking information provided on an expiration date of the designated period (herein, the event period) as final ranking information.

Accordingly, the fandom-index system may grant predetermined stimulation or motivation to fan users to further their fan activities by checking the ranking information provided, and the corresponding ranking information may later function as a reasonable basis for the NFT rewards provided accordingly.

In addition, in an embodiment, the fandom-index system may provide an NFT reward according to the ranking based on the determined temporary fandom-index (S207).

In other words, the NFT reward according to an embodiment may mean a reward provided based on an NFT, which is a unique digital file format stored on a blockchain.

For example, the NFT reward may be an image or video containing a portrait of a predetermined artist (and/or group) stored on a blockchain and/or audio data containing the voice of the artist (and/or group).

In embodiments, such NFT rewards may be provided in either the form of free provision of a predetermined NFT or the form of granting purchase rights for a predetermined NFT.

In detail, in an embodiment, the fandom-index system may provide NFT rewards to at least some of the plurality of fan users based on a ranking determined according to temporary comprehensive activity level information in the temporary fandom-index of the plurality of fan users.

In more detail, in an embodiment, the fandom-index system may detect at least one fan user who satisfies a predetermined criterion (for example, top 10% or top 10 users in ranking) based on the ranking information.

In addition, the fandom-index system may provide the NFT reward through the fan terminal 100 of the detected fan user.

Specifically, in an embodiment, the fandom-index system may provide the NFT reward by issuing a predetermined NFT for free through the fan terminal 100 of the detected fan user.

In addition, in an embodiment, the fandom-index system may provide the NFT reward by granting a purchase right to allow the detected fan user to purchase a predetermined NFT at a predetermined price through the fan terminal 100.

As such, the fandom-index system may select fan users who have performed relatively many fan activities during the corresponding event period and provide the NFT rewards in the form of unique digital files that are the only ones in the world to the selected fan users, thereby increasing the interest and excitement of fan users in event participation and encouraging more active fan activities to obtain more valuable rewards in addition to basic rewards.

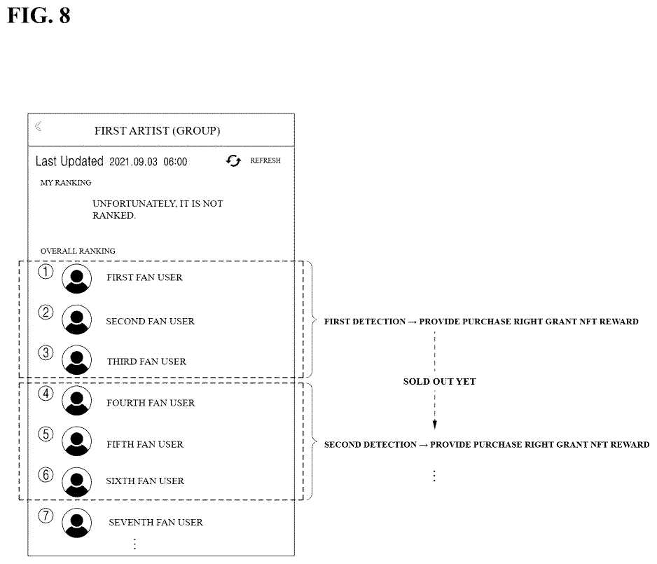

FIG. 8 is an example showing a method for providing a purchase right grant NFT reward according to an embodiment of the present disclosure.

In this connection, referring to FIG. 8, in an embodiment, the fandom-index system provides the purchase right grant NFT reward to the fan terminal 100 of at least one fan user detected primarily. When the NFT is not sold out after a predetermined period has elapsed, the fan index system may secondarily detect at least one fan user who satisfies a predetermined criterion (for example, top 10% of ranking, top 10 people, or the remaining number of the purchase right grant NFT reward) among the remaining fan users excluding the fan users detected primarily.

In addition, in an embodiment, the fandom-index system may further provide the purchase right grant NFT reward through the fan terminal 100 of the second detected fan user.

Depending on an embodiment, the fandom-index system may repeat the aforementioned process until all of the NFTs provided as the purchase right grant NFT reward are sold out, or may repeat the aforementioned process a preset number of times (for example, limited to a third detection).

For example, the fandom-index system may primarily detect a plurality of fan users within top 100 based on the ranking information.

In addition, the fandom-index system may provide each of fan users with the purchase right grant NFT reward that provides the right to purchase an NFT including a portrait image of the first artist at a predetermined price (for example, 10,000 KRW per unit) through each of the fan terminals 100 of the primarily detected 100 fan users.

In other words, the fandom-index system may provide a total of 100 purchase right grant NFT rewards by distributing one to each of the primarily detected 100 fan users.

Thereafter, the fandom-index system may determine whether the 100 NFTs provided are sold out after a predetermined period has passed.

In addition the fandom-index system may compute the remaining number of the purchase right grant NFT rewards when the NFTs are not sold out.

In addition, the fandom-index system may secondarily detect (for example, 30 people) fan users equal to the remaining number of the purchase right grant NFT rewards (for example, 30) from among the remaining fan users excluding the fan users primarily detected based on the ranking information.

In addition, the fandom-index system may further provide each corresponding fan user with the purchase right grant NFT reward that provides the right to purchase an NFT including a portrait image of the first artist at a predetermined price (for example, 10,000 KRW per unit) through each of the fan terminals 100 of the secondarily detected fan users.

In addition, the fandom-index system may repeat the aforementioned process until all of the NFTs are sold out, or repeat the aforementioned process a preset number of times (for example, limited to the third detection).

As such, the fandom-index system may support more fan users to have the opportunity to receive NFT rewards by providing the remaining NFTs to the next-priority fan users when at least some of the NFTs provided through the method of granting purchase rights to first-priority fan users have not been purchased, thereby increasing the sales rate of NFTs.

In this connection, in an embodiment, the fandom-index system may provide customized NFT rewards for each fan user based on the attribute information of the NFT reward (hereinafter, NFT attribute information) and the attribute information of the temporary fandom-index (hereinafter, index attribute information).

In detail, in an embodiment, the fandom-index system may acquire attribute information for each NFT to be provided as a reward.

Herein, the NFT attribute information according to an embodiment is information that specifies the attribute of the corresponding NFT, and may include information on the production target, production section, production time, and/or production format in an embodiment.

Specifically, the production target information of the NFT attribute information may be information that specifies the artist (and/or group) that is the target of the NFT.

In addition, the production section information of the NFT attribute information may be information that specifies the field of activity (history) of the artist (and/or group) related to the NFT, and may be a specific album, a specific tour, or a specific work.

In addition, the production time information of the NFT attribute information may be information that specifies the time at which the NFT is produced and/or used, and may be, for example, the production date, production time, distribution period, and/or distribution cycle.

In addition, the production format information of the NFT attribute information may be information specifying the data file format of the corresponding NFT, and may be, for example, an image, video, and/or audio.

In an embodiment, the fandom-index system may analyze each NFT to be provided as a reward and acquire the NFT attribute information for each NFT. In an embodiment of the present disclosure, the algorithm for analyzing the NFT to derive NFT attribute information is not limited or restricted, and various known algorithms may be utilized to perform this function operation.

In addition, in an embodiment, the fandom-index system may acquire index attribute information for the temporary fandom-index based on the values of each parameter of the temporary fandom-index (in other words, activity target, activity section, activity time, activity type, activity response, and/or activity level in an embodiment).

In other words, in an embodiment, the index attribute information may be information including temporary comprehensive activity target information, temporary comprehensive activity section information, temporary comprehensive activity time information, temporary comprehensive activity type information, temporary comprehensive activity response information, and/or temporary comprehensive activity level information according to the temporary fandom-index.

For example, the fandom-index system may acquire first index attribute information as “First temporary comprehensive activity target information: First artist,” “First temporary comprehensive activity section information: First album,” “First temporary comprehensive activity time information: First period,” “First temporary comprehensive activity type information: Product purchase activity,” “First temporary comprehensive activity response information: 100 likes,” and “First temporary comprehensive activity level information: 10,000 points.”

In addition, in an embodiment, the fandom-index system may compare the attribute information for each NFT and the index attribute information acquired as described above.

In detail, the fandom-index system may compare the values of each parameter (in an embodiment, activity target, activity section, activity time, activity type, activity response, and/or activity level) of the index attribute information with the values of each parameter (in an embodiment, production target, production section, production time, and/or production format) of the attribute information for each NFT corresponding thereto.

In addition, the fandom-index system may detect NFT attribute information having attribute values corresponding to the index attribute information.

For example, the fandom-index system may detect NFT attribute information targeting the first artist when the first temporary comprehensive activity target information of the first index attribute information is “first artist.”

As another example, the fandom-index system may detect NFT attribute information that uses the first period as the production time when the first temporary comprehensive activity time information of first index attribute information is “first period.”

In addition, in an embodiment, the fandom-index system may determine an NFT having the detected NFT attribute information as a customized NFT to be provided to a fan user matching the corresponding temporary fandom-index.

In addition, the fandom-index system may provide the determined customized NFT as an NFT reward to the corresponding fan user.

For example, the fandom-index system may provide an NFT reward (for example, a first artist portrait image NFT) associated with the “first artist” to a first fan user when the first fan user who is matched to the first temporary fandom-index having the first index attribute information mainly performs fan activities related to the “first artist.”

As another example, the fandom-index system may provide an NFT reward (for example, an image NFT including predetermined goods) associated with the “product purchase activity” to a first fan user when the first fan user who is matched to the first temporary fandom-index having the first index attribute information mainly performs fan activities related to the “product purchase activity.”

As such, the fandom-index system analyzes the temporary fandom-index of a fan user who wants to provide a reward, detects the optimal customized NFT that reflects the target or activity method of interest of the fan user based on the activity history so far, and provides the same as a reward, thereby selecting and providing a reward that is associated with the fan user and may act as a greater value, thereby improving the reward satisfaction of the fan user and stimulating future fan activities.

In addition, the fandom-index system may effectively induce continuous participation in fan activities of fan users by providing customized NFT rewards based on the interests of the fan users through analysis of metadata of content consumed by the fan users.

In this connection, according to an embodiment, when there are a plurality of pieces of NFT attribute information having attribute values corresponding to the index attribute information (in other words, when there are a plurality of customized NFTs), the fandom-index system may determine one of the plurality of customized NFTs as a customized main NFT according to the preset index attribute information priority (hereinafter, “attribute priority”).

In other words, in an embodiment, when there is a plurality of pieces of corresponding NFT attribute information detected based on the corresponding index attribute information, such as, for example, there is first NFT attribute information (for example, production target: first artist) corresponding to a first parameter value of the first index attribute information (for example, temporary comprehensive activity target: first artist), there is second NFT attribute information (for example, production section: first album) corresponding to a second parameter value of the first index attribute information (for example, temporary comprehensive activity section: first album), there is third NFT attribute information (for example, production time: first period) corresponding to a third parameter value of the first index attribute information (for example, temporary comprehensive activity time: first period), and there is fourth NFT attribute information (for example, production format: image) corresponding to a fourth parameter value of the first index attribute information (for example, temporary comprehensive activity type: SNS activity), the fandom-index system may determine the customized main NFT based on a preset attribute priority.

In detail, in an embodiment, the fandom-index system may set the attribute priority.

In more detail, in an embodiment, the fandom-index system may set the attribute priorities based on 1) predefined default attribute priorities, based on user settings and/or its own algorithm.

In an embodiment, the fandom-index system may predefine priorities for each parameter (in an embodiment, activity target, activity section, activity time, activity type, activity response, and/or activity level) that configures the index attribute information.

For example, the fandom-index system may predefine priorities for each parameter of the index attribute information, such as “first priority: activity target, second priority: activity section, third priority: activity time, fourth priority: activity type, . . . .”

In addition, the fandom-index system may set the attribute priority according to the predefined priority, in other words, the default attribute priority.

In another embodiment, the fandom-index system may set the attribute priority based on 2) activity information for each parameter configuring the index attribute information (in other words, sub-activity level information in an embodiment).

In detail, in an embodiment, the fandom-index system may determine the priority for each parameter in order of the highest activity point (score) based on the sub-activity level information computed by quantifying the activity level for each parameter as described above.

Alternatively, in an embodiment, the fandom-index system may determine the priority for each parameter in order of the highest ratio of activity points (scores) according to the sub-activity level information.

For example, when a first sub-activity level for a first parameter of the index attribute information is “+100 points,” a second sub-activity level for a second parameter is “+200 points,” and a third sub-activity level for a third parameter is ‘+300 points’, the fandom-index system may determine the attribute priority in the order of third parameter>second parameter>first parameter.

In an embodiment, the fandom-index system may determine any one of the plurality of customized NFTs as the customized main NFT to be ultimately provided to the corresponding fan user based on the attribute priorities set as above.

In detail, in an embodiment, the fandom-index system may detect customized NFT attribute information corresponding to a priority parameter according to the set attribute priority among the plurality of customized NFTs.

For example, when the priority parameter according to the set attribute priority is “activity target,” the fandom-index system may detect a customized NFT (for example, in an embodiment, the first temporary comprehensive activity target information of the first index attribute information is “first artist,” and the NFT attribute information that targets the first artist as a production target is detected as having a corresponding attribute value) detected based on the activity target parameter among the plurality of customized NFTs.

In addition, in an embodiment, the fandom-index system may determine an NFT matching the detected customized NFT attribute information as the customized main NFT.

In addition, in an embodiment, the fandom-index system may provide the determined customized main NFT as an NFT reward to the corresponding fan user.

In an embodiment, the fandom-index system may allow users to input their desired tastes, and create a new NFT based on the input tastes, thereby providing an NFT that includes an image uniquely created to reflect the tastes only of the user, which is the main need for NFTs, as a reward. In this connection, a customized NFT reward may be provided for each fan user by creating an image of the NFT based on the attribute information of the NFT reward (hereinafter, NFT attribute information) and the attribute information of the temporary fandom-index (hereinafter, index attribute information).

To this end, the fandom-index system may include a generative artificial intelligence model that allows users to input their tastes when providing NFT rewards and creates images based on the input tastes of the users and the attribute information. Herein, a stable diffusion model is a representative example of the generative artificial intelligence model, and the description of the image-generating artificial intelligence model will be replaced with the thesis on the stable diffusion model.

These generative artificial intelligence models may be models that additionally learn the images of an artist in addition to conventional generative artificial intelligence models such as stable diffusion, and in which each of a plurality of styles is additionally trained according to the specific attributes of the NFT.

In other words, the generative artificial intelligence model may precisely create an artist image based on the artist of the NFT by additionally learning the plurality of images of each artist.

In addition, the generative artificial intelligence model may additionally learn the style of the artist image for each NFT of the artist.

For example, the generative artificial intelligence model may be trained by designating the first NFTs issued for artist A upon the release of album B as style K, and the second NFTs issued for artist A upon performance B as style L.

In other words, the generative artificial intelligence model may create an artist image of an underlying digital item that is to be reinforced/synthesized, and an upgraded artist image that matches the style of the digital item.

In more detail, users may create a new artist image, which is the main image of the NFT, according to their taste for NFT rewards.

In addition, when a user creates an artist image through an application, the user may induce the creation of the artist image by inputting text, sketch images, or/and photos of desired tastes according to the tastes of the user.

For example, a user may input his or her own photo into the application and input a request in text such as “Create an image of the person in the photo and the artist performing action A (for example, shaking hands).”

The fandom-index system that receives such input may input photos and text into the generative artificial intelligence model to create an image matching the request of a user.

In this connection, the fandom-index system may maintain the attributes of the rewarded NFT by providing additional input to the generative artificial intelligence model to create an image according to attribute information on the NFT reward.

In addition, the fandom-index system may maintain the style attribute of the NFT by providing additional input to create an artist image in the style related to the NFT attribute.

Through this generative artificial intelligence model, users may create their own NFT, which is the main need for NFT digital items, in the direction the users want. In this connection, by maintaining the artist or style attributes of the NFT, the direction of digital item issuance by the artist or agency may be prevented from being changed indiscriminately by the users for a reward.

As such, the fandom-index system selects NFTs related to areas of activity with high fan user interest based on more detailed criteria (such as areas with high fan user activity level in an embodiment) and provides the same as rewards, thereby providing more optimized customized rewards to the fan users, thereby further enhancing the desire to participate in fan activities and increasing the period of stay on the fan platform service, thereby more effectively inducing an increase in active fan activities.

In the above embodiment, it has been described that customized NFT rewards may be provided as described above based on a temporary fandom-index, but an embodiment of providing the customized NFT rewards based on a fandom-index according to an embodiment of the present disclosure may also be included in an embodiment of the present disclosure, and various embodiments may be further possible within the scope that may be implemented by those skilled in the art.

In addition, in an embodiment, the fandom-index system may perform an NFT value-price update based on the determined fandom-index (S111).

In other words, in an embodiment, the fandom-index system may update a value-price for a predetermined NFT based on the plurality of the determined fandom-indices (which may include temporary fandom indices).

In detail, in an embodiment, the fandom-index system may perform an update to re-evaluate the value-price for each NFT based on the activity level information (comprehensive activity information) within the plurality of fandom-indices determined above (which may include temporary fandom-indices).

In more detail, in an embodiment, the fandom-index system may detect at least one NFT corresponding to each of the plurality of fandom-indices in the manner described above.

In other words, in an embodiment, the fandom-index system may detect at least one fandom-index corresponding to each NFT.

In addition, in an embodiment, the fandom-index system may collate and add up each piece of activity level information of at least one fandom-index corresponding to each NFT.

Thus, the fandom-index system may compute an activity level index for each NFT by integrating and quantifying the fan activity level related to each NFT.

For example, the fandom-index system may compute an activity level index for the first NFT by adding up the activity points according to the activity level information of each of the first and second fandom-indices corresponding to the first NFT.

In addition, in an embodiment, when the NFT activity level index computed as above satisfies a predetermined criterion (for example, a preset numerical value), the fandom-index system may perform an update to increase the value-price of an NFT having the corresponding NFT activity level index according to a predetermined method (for example, a preset percentage (%)).

In contrast, in an embodiment, the fandom-index system may perform an update to decrease the value-price of an NFT having the corresponding NFT activity level index by a predetermined method (for example, a predetermined percentage (%)) when the computed NFT activity level index falls below a predetermined criterion (for example, a preset numerical value).

For example, the fandom-index system may perform an update to increase the purchase price of the first NFT when the NFT activity level index for the first NFT (for example, the NFT related to the first artist) is greater than or equal to a predetermined threshold. In contrast, when the NFT activity level index for the first NFT (for example, the NFT related to the first artist) is less than the predetermined threshold, the fandom-index system may perform an update to decrease the purchase price of the first NFT.

As such, the fandom-index system may reasonably and flexibly adjust the value-price of an NFT by performing an update that increases the value-price of the NFT that is highly relevant to fan activities performed relatively by more fan users, and decreases the value-price in the opposite case, thereby reflecting the demand for the NFT by increasing the value-price of the NFT that is determined to be desired by more fan users and to be of greater value.

In addition, in an embodiment, the fandom-index system may provide business insights based on the determined fandom-index (S113).

In detail, in an embodiment, the fandom-index system may create and provide business insights that provide various pieces of statistical data by processing various pieces of data based on the plurality of fandom-indices determined above (including temporary fandom indices) in a predetermined manner (for example, analysis based on activity targets).

For example, the fandom-index system may create and provide various pieces of statistical data, such as total activity level information corresponding to a predetermined artist (and/or group) (in other words, activity index by artist (and/or group)), ranking by activity target according to the activity level index, main activity characteristics according to sub-activity level information, main activity types according to activity points by a predetermined factor, detailed items within main activity types, and main activity times based on data for the plurality of fandom-indices.

According to an embodiment, the fandom-index system may provide business insights as described above by further reflecting at least one additional piece of data (for example, fan user survey result data and/or fan user mission participation data).

As such, the fandom-index system not only provides customized rewards to each fan user based on the fandom-indices (which may include temporary fandom indices) determined according to an embodiment of the present disclosure, but also provides various pieces of statistical data analyzed according to various criteria such as activity targets, thereby satisfying the needs of users who require the same (for example, artist (and/or group) production companies), and may design, establish, and proceed with various plans, management, and services related to fan activities for the artist (and/or group) based on reliable basis data according to the various pieces of statistical data.

Hereinbefore, the fandom-index measurement and reward method according to an embodiment of the present disclosure creates and manages a fandom-index that represents the characteristics of various fan activities performed by fan users by matching the fan activity target and/or the corresponding fan users, thereby easily implementing various services (for example, fandom management, reward provision, and/or event planning) related to the fan activities based on systematized data.

In addition, the fandom-index measurement and reward method according to an embodiment of the present disclosure provides a customized reward that reflects a target of interest or preferred fan activity method of the corresponding fan user based on the fan activity history created based on the fandom-index, thereby providing a reward that has greater value to the fan user. Accordingly, the reward satisfaction of the fan user can be increased and more active and vibrant fan activities can be encouraged in the future.

In addition, the fandom-index measurement and reward method according to an embodiment of the present disclosure analyzes metadata according to the fandom-index and provides customized rewards based on the interests of the fan user, thereby inducing continuous participation of the fan user in fan activities.

In addition, the fandom-index measurement and reward method according to an embodiment of the present disclosure provides a reward in a differentiated manner from the conventional ones based on non-fungible token (NFT) technology, thereby increasing the continuous participation and interest of a wide range of fandom layers including fan users who have been performing fan activities for a long time and new-generation fan users. Accordingly, the user retention time on a fan platform service can be increased, and various benefits resulting from increased fan activities can be implemented more effectively.

The embodiments of the present disclosure described above may be implemented in the form of program commands which may be executed through various types of computer constituting elements and recorded in a computer-readable recording medium. The computer-readable recording medium may include program commands, data files, and data structures separately or in combination thereof. The program commands recorded in the computer-readable recording medium may be those designed and configured specifically for the present disclosure or may be those commonly available for those skilled in the field of computer software. Examples of a computer-readable recoding medium may include magnetic media such as hard-disks, floppy disks, and magnetic tapes; optical media such as CD-ROMs and DVDs; and hardware devices specially designed to store and execute program commands such as ROM, RAM, and flash memory. Examples of program commands include not only machine codes such as those generated by a compiler but also high-level language codes which may be executed by a computer through an interpreter and the like. The hardware device may be replaced with by one or more software modules to perform the operations of the present disclosure, and vice versa.

### INDUSTRIAL APPLICABILITY

An embodiment of the present disclosure provides a method for measuring a activity of a user toward an artist and providing a reward in the form of an NFT using a blockchain network, and thus has industrial applicability.

1. A fandom-index measurement and reward method by which at least one processor of a fan platform service server measures and rewards according to a fandom-index, the method comprising:
collecting fan activity data on each fan user;
determining, based on the collected fan activity data, the fandom-index comprising activity level information on the each fan user;
providing ranking information between the fan users for a predetermined activity target based on the activity level information in the determined fandom-index; and
providing a non-fungible token (NFT) reward according to the ranking information.

2. The method of claim 1, wherein the NFT reward is provided based on an NFT, which is a digital file registered on a blockchain.

3. The method of claim 2, wherein the provision of the NFT reward according to the ranking information comprises providing the NFT reward in at least one of an NFT free provision method or an NFT purchase right provision method.

4. The method of claim 3, wherein the fan activity data comprises at least one piece of parameter information among activity target information that specifies the activity target that is a target of a fan activity, activity section information that specifies a field of the fan activity, activity time information that specifies a time of the fan activity, activity type information that specifies details of the fan activity, activity response information that specifies responses of other users to the fan activity, and the activity level information that numerically specifies a level of the fan activity performed.

5. The method of claim 4, wherein the provision of the NFT reward according to the ranking information comprises:
acquiring attribute information for the each NFT;
comparing the acquired attribute information for the each NFT with attribute information of the fandom-index determined based on each parameter value of the fan activity data;
detecting NFT attribute information corresponding to the attribute information of the fandom-index according to the comparison; and
providing a customized NFT having the detected NFT attribute information as a reward.

6. The method of claim 5, wherein the NFT attribute information comprises at least one piece of parameter information among production target information that specifies a production target of the NFT, production section information that specifies a field of activity of the production target, production time information that specifies a time of production and use of the NFT, and production format information that specifies a data file format of the NFT.

7. The method of claim 6, wherein the comparison of the attribute information for the each NFT with the attribute information of the fandom-index comprises comparing each parameter value of the attribute information for the each NFT with each parameter value of the attribute information of the fandom-index corresponding thereto.

8. The method of claim 7, wherein the provision of the customized NFT as the reward comprises:
when there are a plurality of detected customized NFTs, determining one of the plurality of customized NFTs as a customized main NFT based on priority information preset for each parameter of the attribute information of the fandom-index; and
providing the determined customized main NFT as the reward.

9. The method of claim 8, further comprising presetting the priority information, wherein the presetting of the priority information comprises presetting the priority information based on at least one of sub-activity level information or default priority that divides the activity level information for each parameter of the attribute information of the fandom-index.

10. The method of claim 1, wherein the collection of the fan activity data comprises collecting first fan activity data based on an internal service and second fan activity data based on an external service.

11. The method of claim 10, wherein the determination of the fandom-index comprises collating the first fan activity data and the second fan activity data by corresponding parameter of each piece of fan activity data, wherein the collation by parameter comprises determining comprehensive activity level information of the fandom-index by adding up first activity level information of the first fan activity data and second activity level information of the second fan activity data.

12. The method of claim 1, wherein the provision of the NFT reward according to the ranking information comprises:
detecting at least some fan users who meet a predetermined criterion based on the activity level information among the fan users; and
providing the NFT reward through terminals of the detected fan users.

13. A fandom-index measurement and reward method by which a fan platform application executed by at least one processor of a fan terminal measures and rewards according to a fandom-index, the method comprising:
creating fan activity data;
acquiring the fandom-index according to the created fan activity data;
providing predetermined ranking information based on activity level information in the acquired fandom-index; and
providing a non-fungible token (NFT) reward according to the provided ranking information.

14. The method of claim 13, wherein the provision of the NFT reward according to the ranking information comprises providing the NFT reward when a predetermined criterion based on the activity level information is satisfied.

15. The method of claim 14, wherein the provision of the NFT reward according to the ranking information comprises providing the NFT reward in at least one of an NFT free provision method or an NFT purchase right provision method.
